(19) United States
(12) Patent Application Publication
(10) Pub. No.: US 2019/0026440 A1
(43) Pub. Date: Jan. 24, 2019

(54) NUCLEAR RECEPTOR SET DOMAIN CONTAINING PROTEIN 2 TRANSITION STATE AND USES THEREOF

(71) Applicant: ALBERT EINSTEIN COLLEGE OF MEDICINE, INC., Bronx, NY (US)

(72) Inventors: Vern L. Schramm, New Rochelle, NY (US); Myles B. Poulin, Bronx, NY (US)

(73) Assignee: ALBERT EINSTEIN COLLEGE OF MEDICINE, INC., Bronx, NY (US)

(21) Appl. No.: 16/060,470

(22) PCT Filed: Dec. 14, 2016
(86) PCT No.: PCT/US16/66514

§ 371 Date: Jun. 8, 2018

Related U.S. Application Data
(60) Provisional application No. 62/268,677, filed on Dec. 17, 2015.

(51) Int. Cl. G06F 19/00; G06F 17/30; G06F 19/12; G06F 19/24

(52) U.S. Cl. CPC G06F 19/706; G06F 17/30; C40B 20/08; G06F 19/24; G06F 19/12

(57) ABSTRACT

Methods and systems for obtaining inhibitors of Nuclear receptor SET Domain containing protein 2 (NSD2) are disclosed where the methods involve designing compounds that resemble the NSD2 transition state.

### CROSS REFERENCE TO RELATED APPLICATIONS

This application is a U.S. national stage entry under 35 U.S.C. § 371 of PCT International Patent Application No. PCT/US2016/066514, filed Dec. 14, 2016, which claims the benefit of U.S. Provisional Patent Application No. 62/268,677, filed Dec. 17, 2015, the contents of each of which are incorporated herein by reference into the subject application.

### STATEMENT OF GOVERNMENT SUPPORT

This invention was made with government support under grant number GM041916 awarded by the National Institutes of Health. The government has certain rights in the invention.

### FIELD OF THE INVENTION

The invention relates to systems and methods for obtaining inhibitors of Nuclear receptor SET Domain containing protein 2 (NSD2) by designing compounds that resemble the charge and geometry of the NSD2 transition state.

### BACKGROUND OF THE INVENTION

Throughout this application various publications are referred to in parentheses. Full citations for these references may be found at the end of the specification before the claims. The disclosures of these publications are hereby incorporated by reference in their entireties into the subject application to more fully describe the art to which the subject application pertains.

Histone lysine methylation is an essential posttranslational modification for transcriptional regulation, DNA damage response, and chromatin regulation (1, 2). Methyl groups (Me, CH₃) are installed on lysine residues by protein lysine methyltransferase enzymes (PKMTs), the majority of which, in humans, contain a catalytic SET domain (3). The conserved SET domain catalyzes the transfer of between one to three CH₃ from S-adenosyl-L-methionine (SAM) onto the ε-amino group of lysine residues (FIG. 1) producing mono-, di-, or trimethyl lysine derivatives (KMe1, KMe2, and KMe3 respectively) (3), in a reaction that involves first deprotonation of the lysine, and finally transfer of the methyl group (4, 5).

Histone lysine Me marks can signal either transcriptional activation or repression depending on which lysine residue is methylated and the number of transferred Me groups (2). For example, histone H3 lysine 27 trimethylation is a signal for transcriptional repression (6), where histone H3 lysine 4 and histone H3 lysine 36 Me marks are found in actively transcribed loci (7). As a result, mis-regulation of PKMT expression is often associated with cancer development and other disease states (8). Deletion of the gene encoding the histone H3K36 dimethyltransferase enzyme nuclear receptor binding SET domain protein 2 (NSD2, also known as WHSC1 or MMSET), specifically, is present in the developmental disorder Wolf Hirschhorn syndrome (9). By contrast, NSD2 overexpression, as a result of a t (4, 14) chromosomal translocation (10), is present in 15% of multiple myeloma cases and has been identified in other cancers (11-13). NSD2 catalyzes the mono- and dimethylation of histone H3K36, in vivo (11), although other CH₃-transfer specificities have also been reported in studies using histone protein or histone tail peptide as substrate analogs (14-16). Studies using isolated or recombinant nucleosome as physiologically relevant substrates detected H3K36Me1 and H3K36Me2 as the exclusive products. Thus the nature of the substrate can influence NSD2 specificity (11, 17). Substrate specificity is also influenced by the presence of a C-terminal basic post-SET extension found in NSD family methyltransferases. NSD2 mutants lacking this basic post-SET extension are unable to recognize nucleosome as substrate (18). The H3K36Me2 marks introduced by NSD2 are normally concentrated in the 5′ end of actively transcribed genes (7), and overexpression results in global increases in H3K36Me2 throughout gene bodies resulting in aberrant transcription of multiple oncogenes (19). Histone methylation is a reversible posttranslational modification, thus inhibiting the catalytic activity of NSD2 is an attractive strategy for the treatment of multiple myeloma and other cancers.

Designing analogues that mimic the geometry and charge distribution of transition states (TSs) of enzyme catalyzed reactions is a powerful approach for enzyme inhibition (20-21, 59-63); however, this requires a detailed model of the enzyme TS. TS models for a number of PKMT enzymes, including human SET8 (22) and SETT/9 (4, 23) based on QM/MM calculation of the enzyme chemistry, show substantial variability in the predicted TS geometry of PKMT. However, these models have not been verified experimentally. Detailed information about TS structure can be obtained from the measurement of kinetic isotope effects (KIEs) (24), which result from changes in the bond vibrational environment for atoms of the reactants free in solution and at the TS (24). The measurement of multiple KIEs combined with quantum chemical calculations allow for interrogation of TS structure (20, 21, 25). The present invention uses the NSD2 TS to address the need for new inhibitors for NSD2, particularly ones that will be effective in cancer therapy.

### SUMMARY OF THE INVENTION

The invention provides methods of obtaining inhibitors of human Nuclear receptor SET Domain containing protein 2 (NSD2) comprising designing a chemically stable compound that resembles the charge and geometry of the NSD2 transition state.

The invention also provides systems for obtaining a putative inhibitor of a human Nuclear receptor SET Domain containing protein 2 (NSD2) comprising one or more data processing apparatus and a computer-readable medium coupled to the one or more data processing apparatus having instructions stored thereon that are configured to perform a method comprising designing a chemically stable compound that resembles the charge and geometry of the NSD2 transition state, wherein the compound is a putative inhibitor of NSD2.

The invention further provides methods for screening for a compound that is an inhibitor of human Nuclear receptor SET Domain containing protein 2 (NSD2), the method comprising the steps of:

(i) determining the molecular electrostatic potential at the van der Waals surface computed from the wave function of a NSD2 transition state and the geometric atomic volume of the NSD2 transition state, wherein the NSD2 transition state comprises the structure

(ii) designing a chemically stable compound that resembles the molecular electrostatic potential at the van der Waals surface computed from the wave function of the NSD2 transition state and the geometric atomic volume of the NSD2 transition state;

(iii) synthesizing the compound; and

(iv) testing the compound for inhibitory activity to NSD2.

The invention further provides methods of screening for an inhibitor of human Nuclear receptor SET Domain containing protein 2 (NSD2), the method comprising the steps of:

(i) measuring kinetic isotope effects on the NSD2-catalyzed methylation of histone H3 lysine 36 to obtain the NSD2 transition state structure,

wherein the NSD2 transition state comprises the structure

(ii) determining the molecular electrostatic potential at the van der Waals surface computed from the wave function of the NSD2 transition state and the geometric atomic volume of the NSD2 transition state;

(iii) obtaining a chemically stable compound that resembles the molecular electrostatic potential at the van der Waals surface computed from the wave function of the NSD2 transition state and the geometric atomic volume of the NSD2 transition state; and

(iv) testing the compound for inhibitory activity to NSD2 by determining if the compound inhibits NSD2-catalyzed methylation of histone H3 lysine 36,

wherein a compound that inhibits NSD2-catalyzed methylation of histone H3 lysine 36 is an inhibitor of NSD2.

The invention also provides systems comprising a non-transitory computer-readable medium coupled to one or more data processing apparatus having instructions stored thereon which, when executed by the one or more data processing apparatus, cause the one or more data processing apparatus to perform a method comprising:

(i) obtaining kinetic isotope effects on human Nuclear receptor SET Domain containing protein 2 (NSD2)-catalyzed methylation of histone H3 lysine 36 to obtain the NSD2 transition state structure,

wherein the NSD2 transition state comprises the structure

(ii) determining the molecular electrostatic potential at the van der Waals surface computed from the wave function of the NSD2 transition state and the geometric atomic volume of the NSD2 transition state; and

(iii) identifying from a library of compounds a chemically stable compound that resembles the molecular electrostatic potential at the van der Waals surface computed from the wave function of the NSD2 transition state and the geometric atomic volume of the NSD2 transition state;

wherein the chemically stable compound that resembles the molecular electrostatic potential at the van der Waals surface computed from the wave function of the NSD2 transition state and the geometric atomic volume of the NSD2 transition state is a putative inhibitor of NSD2.

The invention also provides systems comprising a non-transitory computer-readable medium coupled to one or more data processing apparatus having instructions stored thereon which, when executed by the one or more data processing apparatus, cause the one or more data processing apparatus to perform a method comprising:

(i) determining the molecular electrostatic potential at the van der Waals surface computed from the wave function of a human Nuclear receptor SET Domain containing protein 2 (NSD2) transition state and the geometric atomic volume of the NSD2 transition state, wherein the NSD2 transition state comprises the structure

and

(ii) designing a chemically stable compound that resembles the molecular electrostatic potential at the van der Waals surface computed from the wave function of the NSD2 transition state and the geometric atomic volume of the NSD2 transition state;

wherein a chemically stable compound that resembles the molecular electrostatic potential at the van der Waals surface computed from the wave function of the NSD2 transition state and the geometric atomic volume of the NSD2 transition state is a putative inhibitor of NSD2.

The invention also provides computer implemented methods performed using a system comprising a non-transitory computer-readable medium coupled to one or more data processing apparatus having instructions stored thereon, the methods comprising:

(i) obtaining kinetic isotope effects on human Nuclear receptor SET Domain containing protein 2 (NSD2)-catalyzed methylation of histone H3 lysine 36 to obtain the NSD2 transition state structure,

wherein the NSD2 transition state comprises the structure

(ii) determining the molecular electrostatic potential at the van der Waals surface computed from the wave function of the NSD2 transition state and the geometric atomic volume of the NSD2 transition state; and

(iii) identifying from a library of compounds a chemically stable compound that resembles the molecular electrostatic potential at the van der Waals surface computed from the wave function of the NSD2 transition state and the geometric atomic volume of the NSD2 transition state;

wherein the chemically stable compound that resembles the molecular electrostatic potential at the van der Waals surface computed from the wave function of the NSD2 transition state and the geometric atomic volume of the NSD2 transition state is a putative inhibitor of NSD2.

The invention also provides computer implemented methods performed using a system comprising a non-transitory computer-readable medium coupled to one or more data processing apparatus having instructions stored thereon, the methods comprising:

(i) determining the molecular electrostatic potential at the van der Waals surface computed from the wave function of a human Nuclear receptor SET Domain containing protein 2 (NSD2) transition state and the geometric atomic volume of the NSD2 transition state, wherein the NSD2 transition state comprises the structure

and

(ii) designing a chemically stable compound that resembles the molecular electrostatic potential at the van der Waals surface computed from the wave function of the NSD2 transition state and the geometric atomic volume of the NSD2 transition state;

wherein a chemically stable compound that resembles the molecular electrostatic potential at the van der Waals surface computed from the wave function of the NSD2 transition state and the geometric atomic volume of the NSD2 transition state is a putative inhibitor of NSD2.

### BRIEF DESCRIPTION OF THE DRAWINGS

FIG. 1A-1B. NSD2 catalyzed methylation of histone H3 lysine 36 (H3 K36). (A) The general reaction catalyzed by NSD2 showing both mono- and dimethylation of H3K36. (B) Product distribution for methylation of HeLa cell mononucleosomes (HeLaNuc) with [Me-²H₃]SAM. Products are shown for the histone H3 (K27-R40) peptide resulting from Arg-C digestion. NSD2 displays a preference for dimethylation H3 K36.

FIG. 2A-2B. Determination of intrinsic KIEs correcting for forward commitment factor (C_{f}). (A) Measurement of C_{f} by isotope trapping for the methylation of HeLa cell nucleosome H3 K36 by NSD2. (B) Intrinsic KIE values by atom position after correction for C_{f}. Errors are reported as the standard deviation of at least six replicates from two independent experiments.

FIG. 3A-3C. Theoretical transition state model for NSD2 methylation of H3K36. (A) A prediction of the lysine substrate geometry from the structure NSD1 overlaid with the with peptide substrates of SETT/9 (PDB ID 1XQH, 2F69) SET8 (PDB ID 3F9W, 3F9Y) and PIM5 (PDB 1PEG). (B) A simplified TS model for the NSD2 methyltransfer reaction derived from the SAM and lysine geometry. (C) KIEs predicted for TS1 at different fixed C—N and C—S distances.

FIG. 4. Geometry and electrostatic potential surface of the NSD2 TS structure. TS structure for H3 K36 methylation catalyzed by NSD2 with active site amino acids F1117, M1140 and Y1179 (TS2).

FIG. 5A-5B. Analysis of products resulting from the methylation of HeLaNuc catalyzed by NSD2. (A) A diagram showing the H3 peptide containing Lys27-Arg40 resulting from ArgC digestion of HeLaNuc that was methylated by NSD2 in vitro. (B) LC-MS analysis of the products resulting from methylation of HeLaNuc showed only mono- and dimethylation of H3K36 for starting peptides containing between 0-3 pre-existing methyl marks. H3K36 methylation was confirmed by LC-MS/MS, data not shown.

FIG. 6A-6B. Theoretical structure of the TS for NSD2 methylation of H3 K36. (A) A simplified TS model calculated for the NSD2 methyltransfer reaction using M062x/6-31G*. (B) Relationships between TS geometry and predicted KIEs. KIEs calculated using the program ISOEFF98 are plotted at varying C—N and C—S distances. Observed KIEs are shown as a dashed line with the standard deviation shown as dotted lines.

FIG. 7A-7B. Theoretical structure of the TS for NSD2 methylation of H3 K36Mel. (A) A simplified TS model calculated for the NSD2 methyltransfer reaction using M062x/6-31G*. (B) Relationships between TS geometry and predicted KIEs. KIEs calculated using the program ISOEFF98 are plotted at varying C—N and C—S distances. Observed KIEs are shown as a dashed line with the standard deviation shown as dotted lines.

FIG. 8. Effect of MeC—S—C5′-C4′ dihedral angle on predicted 5′-³H₂ KIEs. KIEs were calculated for TS1 where the MeC—S—C5′-C4′ dihedral angle is rotated from equilibrium.

FIG. 9. Predicted Me-¹⁴C KIEs including contributions from QM tunneling. Predicted KIEs were calculated using the program ISOEFF98 for TS1 with fixed C—S and C—N distances and including a correction for QM tunneling. The intrinsic Me-¹⁴C KIE is shown as a dashed line.

### DETAILED DESCRIPTION OF THE INVENTION

The invention provides a method of obtaining a putative inhibitor of human Nuclear receptor SET Domain containing protein 2 (NSD2), the method comprising using a computer to design a chemically stable compound that resembles the charge and geometry of the NSD2 transition state, wherein the compound is a putative inhibitor of NSD2.

The invention also provides a system for obtaining a putative inhibitor of human Nuclear receptor SET Domain containing protein 2 (NSD2) comprising one or more data processing apparatus and a computer-readable medium coupled to the one or more data processing apparatus having instructions stored thereon that are configured to perform a method comprising designing a chemically stable compound that resembles the charge and geometry of the NSD2 transition state, wherein the compound is a putative inhibitor of NSD2.

The method can include the steps of:

(i) determining the molecular electrostatic potential at the van der Waals surface computed from the wave function of a NSD2 transition state and the geometric atomic volume of the NSD2 transition state, and

(ii) designing a chemically stable compound that resembles the molecular electrostatic potential at the van der Waals surface computed from the wave function of the NSD2 transition state and the geometric atomic volume of the NSD2 transition state, wherein the compound is a putative inhibitor of NSD2.

As disclosed herein, the NSD2 transition state structure can comprise

Preferably, the transition state is a S_{N}2 transition state where a positive charge is distributed between a leaving group, a transferring group and a nucleophile. Preferably, the transition state has a C—N distance of 1.8 Å and a C—S distance of 2.6 Å, or the transition state has a C—N distance of 2.10 Å and a C—S distance of 2.53 Å.

The invention further provides a method for screening for a compound that is an inhibitor of human Nuclear receptor SET Domain containing protein 2 (NSD2), the method comprising the steps of:

(i) determining the molecular electrostatic potential at the van der Waals surface computed from the wave function of a NSD2 transition state and the geometric atomic volume of the NSD2 transition state, wherein the HIV-1 protease transition state comprises the structure

(ii) using a computer to design a chemically stable compound that resembles the molecular electrostatic potential at the van der Waals surface computed from the wave function of the NSD2 transition state and the geometric atomic volume of the NSD2 transition state;

(iii) synthesizing the compound; and

(iv) testing the compound for inhibitory activity to HIV-1 protease.

The invention further provides a method of screening for an inhibitor of human Nuclear receptor SET Domain containing protein 2 (NSD2), the method comprising the steps of:

(i) measuring kinetic isotope effects on the NSD2-catalyzed methylation of histone H3 lysine 36 to obtain the NSD2 transition state structure,

wherein the NSD2 transition state comprises the structure

(ii) determining the molecular electrostatic potential at the van der Waals surface computed from the wave function of the NSD2 transition state and the geometric atomic volume of the NSD2 transition state;

(iii) obtaining a chemically stable compound that resembles the molecular electrostatic potential at the van der Waals surface computed from the wave function of the NSD2 transition state and the geometric atomic volume of the NSD2 transition state; and

(iv) testing the compound for inhibitory activity to NSD2 by determining if the compound inhibits NSD2-catalyzed methylation of histone H3 lysine 36,

wherein a compound that inhibits NSD2-catalyzed methylation of histone H3 lysine 36 is an inhibitor of NSD2.

The invention also provides a system comprising a non-transitory computer-readable medium coupled to one or more data processing apparatus having instructions stored thereon which, when executed by the one or more data processing apparatus, cause the one or more data processing apparatus to perform a method comprising:

(i) obtaining kinetic isotope effects on human Nuclear receptor SET Domain containing protein 2 (NSD2)-catalyzed methylation of histone H3 lysine 36 to obtain the NSD2 transition state structure,

wherein the NSD2 transition state comprises the structure

(ii) obtaining the molecular electrostatic potential at the van der Waals surface computed from the wave function of the NSD2 transition state and the geometric atomic volume of the NSD2 transition state; and

(iii) identifying from a library of compounds a chemically stable compound that resembles the molecular electrostatic potential at the van der Waals surface computed from the wave function of the NSD2 transition state and the geometric atomic volume of the NSD2 transition state;

wherein the chemically stable compound that resembles the molecular electrostatic potential at the van der Waals surface computed from the wave function of the NSD2 transition state and the geometric atomic volume of the NSD2 transition state is a putative inhibitor of NSD2.

The invention also provides a system comprising a non-transitory computer-readable medium coupled to one or more data processing apparatus having instructions stored thereon which, when executed by the one or more data processing apparatus, cause the one or more data processing apparatus to perform a method comprising:

(i) obtaining the molecular electrostatic potential at the van der Waals surface computed from the wave function of a human Nuclear receptor SET Domain containing protein 2 (NSD2) transition state and the geometric atomic volume of the NSD2 transition state, wherein the NSD2 transition state comprises the structure

and

(ii) designing a chemically stable compound that resembles the molecular electrostatic potential at the van der Waals surface computed from the wave function of the NSD2 transition state and the geometric atomic volume of the NSD2 transition state;

wherein a chemically stable compound that resembles the molecular electrostatic potential at the van der Waals surface computed from the wave function of the NSD2 transition state and the geometric atomic volume of the NSD2 transition state is a putative inhibitor of NSD2.

The invention also provides a computer implemented method performed using a system comprising a non-transitory computer-readable medium coupled to one or more data processing apparatus having instructions stored thereon, the method comprising:

(i) obtaining kinetic isotope effects on human Nuclear receptor SET Domain containing protein 2 (NSD2)-catalyzed methylation of histone H3 lysine 36 to obtain the NSD2 transition state structure,

wherein the NSD2 transition state comprises the structure

(ii) obtaining the molecular electrostatic potential at the van der Waals surface computed from the wave function of the NSD2 transition state and the geometric atomic volume of the NSD2 transition state; and

(iii) identifying from a library of compounds a chemically stable compound that resembles the molecular electrostatic potential at the van der Waals surface computed from the wave function of the NSD2 transition state and the geometric atomic volume of the NSD2 transition state;

wherein the chemically stable compound that resembles the molecular electrostatic potential at the van der Waals surface computed from the wave function of the NSD2 transition state and the geometric atomic volume of the NSD2 transition state is a putative inhibitor of NSD2.

The invention also provides a computer implemented method performed using a system comprising a non-transitory computer-readable medium coupled to one or more data processing apparatus having instructions stored thereon, the method comprising:

(i) determining the molecular electrostatic potential at the van der Waals surface computed from the wave function of a human Nuclear receptor SET Domain containing protein 2 (NSD2) transition state and the geometric atomic volume of the NSD2 transition state, wherein the NSD2 transition state comprises the structure

and

(ii) designing a chemically stable compound that resembles the molecular electrostatic potential at the van der Waals surface computed from the wave function of the NSD2 transition state and the geometric atomic volume of the NSD2 transition state;

wherein a chemically stable compound that resembles the molecular electrostatic potential at the van der Waals surface computed from the wave function of the NSD2 transition state and the geometric atomic volume of the NSD2 transition state is a putative inhibitor of NSD2.

The methods can also comprise synthesizing the putative inhibitor compound and/or testing the compound for inhibitory activity to NSD2.

The invention also provides methods of inhibiting NSD2 comprising obtaining a NSD2 inhibitor by any of the methods disclosed herein or by using any of the systems disclosed herein, and contacting NSD2 with the compound.

The invention further provides methods of treating a subject having a cancer comprising obtaining a NSD2 inhibitor by any of the methods disclosed herein or by using any of the systems disclosed herein, and administering the compound to the subject in an amount effective to inhibit NSD2. The subjects can have different types of cancers, including but not limited to, a multiple myeloma, a neuroblastoma, a glioblastoma, prostate cancer and/or breast cancer.

The invention still further provides compounds obtained by any of the methods disclosed herein or by using any of the systems disclosed herein.

As used herein, a compound resembles the NSD2 transition state molecular electrostatic potential at the van der Waals surface computed from the wave function of the transition state and the geometric atomic volume if that compound has an Sₑ and S_{g}≥0.5, where Sₑ and S_{g} are determined as in Formulas (1) and (2) on page 8831 of Bagdassarian, Schramm and Schwartz, 1996 (58).

Page 8831 of Bagdassarian et al. 1996 (58) sets forth in part “[a] molecule can be compared to another either geometrically or electrostatically, but ideally, a similarity measure will contain a mixture of both. Consider first the measure

$${S}_{e} = \frac{{\sum }_{i = 1}^{n A} {\sum }_{j = 1}^{nB} {ϵ}_{i}^{A} {ϵ}_{j}^{B} exp ( - α {r}_{ij}^{2} )}{\sqrt{{\sum }_{i = 1}^{n A} {\sum }_{j = 1}^{n A} {ϵ}_{i}^{A} {ϵ}_{j}^{A} exp ( - α {r}_{ij}^{2} )} \sqrt{{\sum }_{i = 1}^{n B} {\sum }_{j = 1}^{nB} {ϵ}_{i}^{B} {ϵ}_{j}^{B} exp ( - α {r}_{ij}^{2} )}} \qquad ( 1 )$$

where ϵᵢ^{A} is the electrostatic potential at surface point i of molecule A, ϵⱼ^{B} defines point j of molecule B, and in the numerator rᵢⱼ² is the spatial distance squared between point i on A and j on B. nA and nB refer to the number of surface points on each molecule. The double summation is therefore over all possible interactions between points on the two molecules, and α is the length scale for the interaction between i and j. The numerator compares A to B for a particular orientation of molecule B relative to molecule A. The denominator serves as a normalization factor for the comparison of A to itself and for B to itself. Here, rᵢⱼ² refers to the distance between i and j on the same molecule. The distance between points is squared to decrease computation time. Consider also a second, purely geometrical measure:

$${S}_{g} = \frac{{\sum }_{i = 1}^{n A} {\sum }_{j = 1}^{nB} exp ( - α {r}_{ij}^{2} )}{\sqrt{{\sum }_{i = 1}^{n A} {\sum }_{j = 1}^{n A} exp ( - α {r}_{ij}^{2} )} \sqrt{{\sum }_{i = 1}^{n B} {\sum }_{j = 1}^{nB} exp ( - α {r}_{ij}^{2} )}} . ” \qquad ( 2 )$$

The invention provides methods and systems that provide a technical solution to enable obtaining inhibitors for NSD2, particularly ones that will be effective in cancer therapy. The disclosed methods enhance the performance of the system in obtaining the inhibitors.

This invention will be better understood from the Experimental Details that follow. However, one skilled in the art will readily appreciate that the specific methods and results discussed are merely illustrative of the invention as described more fully in the claims that follow thereafter.

### EXPERIMENTAL DETAILS

### Overview

Nuclear receptor SET domain containing protein 2 (NSD2) catalyzes the methylation of histone H3 lysine 36 (H3K36). It is overexpressed in human multiple myeloma and several other human cancers. Despite the relevance of NSD2 to cancer, there have been no potent selective inhibitors of this enzyme reported. Here, a combination of kinetic isotope effect measurements and quantum chemical modeling was used to provide sub-Å details of the transition state structure for NSD2 enzymatic activity. Kinetic isotope effects were measured for the methylation of isolated HeLa cell nucleosomes by NSD2. NSD2 preferentially catalyzes the dimethylation of H3K36 along with a reduced preference for H3K36 monomethylation. Primary [Me-¹⁴C] and [³⁶S] and secondary [Me-³H₃], [Me-²H₃], [5′-¹⁴C] and [5′-³H₂] kinetic isotope effects were measured for the methylation of

H3K36 using specifically labeled S-adenosyl-L-methionine. The intrinsic kinetic isotope effects were used as boundary constraints for quantum mechanical calculations for the NSD2 transition state. The experimental and calculated kinetic isotope effects are consistent with an S_{N}2 chemical mechanism with methyl transfer as the first irreversible chemical step in the reaction mechanism. The transition state is a late, asymmetric nucleophilic displacement with bond separation of the leaving group more advanced (2.53 Å) and bond-making to the nucleophile (2.10 Å) more advanced at the transition state. The transition state structure can be represented in a molecular electrostatic potential map to guide the design of inhibitors that mimic the transition state geometry and charge.

### Materials and Methods

Materials. L-[Me-¹⁴C]Methionine and L-[Me-³H₃]methionine were purchased from PerkinElmer, Inc. D[1-³H]Ribose, D[6-³H₂]glucose, D[6-¹⁴C]glucose, and [8-¹⁴C]adenine were purchased from American Radiolabeled Chemicals, Inc. L-[Me-²H₃]methionine was purchased from Cambridge Isotope Laboratories, Inc. Hexokinase pyruvate kinase, myokinase, phosphoriboisomerase, glucose-6-phosphate dehydrogenase, glutamic acid dehydrogenase and 6-phosphogluconic acid dehydrogenase were purchased from Sigma-Aldrich. Adenine phosphoribosyltransferase, phosphoribosyl-α-1-pyrophosphate synthetase, and ribokinase and SAM synthetase (SAMsyn) were prepared as previously described (51-53). HeLa cell nucleosome (HeLaNuc) were extracted and purified as primarily mono- and di-nucleosome from cultured HeLa cells as previously described (54). Other chemicals and reagents were obtained from commercial sources and used without further purification. Human NSD2 SET domain (amino acid residues 980-1365) was expressed recombinantly and purified, and contained no bound SAM or SAH.

Human NSD2 has the amino acid sequence (NCBI Accession No. 096028, SEQ ID NO:1):

| | |
|---|---|
| 1 | mefsikqspl svqsvvkcik mkqapeilgs angktpscev nrecsvflsk aqlssslqeg |
| 61 | vmqkfnghda lpfipadklk dltsrvfnge pgandaklrf esqemkgigt ppnttpikng |
| 121 | speiklkitk tymngkplfe ssicgdsaad vsqseengqk penkarrnrk rsikydslle |
| 181 | qglveaalvs kisspsdkki pakkescpnt grdkdhllky nvgdlvwskv sgypwwpcmv |
| 241 | sadpllhsyt klkgqkksar qyhvqffgda perawifeks lvafegegqf eklcqesakq |
| 301 | aptkaekikl lkpisgklra qwemgivqae eaasmsveer kakftflyvg dqlhlnpqva |
| 361 | keagiaaesl gemaessgvs eeaaenpksv reecipmkrr rraklcssae tleshpdigk |
| 421 | stpqktaead prrgvgsppg rkkttvsmpr srkgdaasqf lvfcqkhrde vvaehpdasg |
| 481 | eeieellrsq wsllsekqra ryntkfalva pvqaeedsgn vngkkrnhtk riqdptedae |
| 541 | aedtprkrlr tdkhslrkrd titdktarts sykameaass lksqaatknl sdackplkkr |
| 601 | nrastaassa lgfsksssps asltenevsd spgdepsesp yesadetqte vsvsskkser |
| 661 | gvtakkeyvc qlcekpgsll lcegpccgaf hlaclglsrr pegrftcsec asgihscfvc |
| 721 | kesktdvkrc vvtqcgkfyh eacvkkyplt vfesrgfrcp lhscvschas npsnprpskg |
| 781 | kmmrcvrcpv ayhsgdacla agcsviasns iictahftar kgkrhhahvn vswcfvcskg |
| 841 | gsllccescp aafhpdclni empdgswfcn dcragkklhf qdiiwvklgn yrwwpaevch |
| 901 | pknvppniqk mkheigefpv fffgskdyyw thqarvfpym egdrgsryqg vrgigrvfkn |
| 961 | alqeaearfr eiklqreare tqeserkppp ykhikvnkpy gkvqiytadi seipkcnckp |
| 1021 | tdenpcgfds eclnrmlmfe chpqvcpage fcqnqcftkr qypetkiikt dgkgwglvak |
| 1081 | rdirkgefvn eyvgelidee ecmarikhah endithfyml tidkdriida gpkgnysrfm |
| 1141 | nhscqpncet lkwtvngdtr vglfavcdip agteltfnyn ldclgnektv crcgasncsg |
| 1201 | flgdrpktst tlsseekgkk tkkktrrrra kgegkrqsed ecfrcgdggq lvlcdrkfct |
| 1261 | kayhlsclgl gkrpfgkwec pwhhcdvcgk pstsfchlcp nsfckehqdg tafsctpdgr |
| 1321 | syccehdlga asvrstktek pppepgkpkg krrrrrgwrr vtegk. |

Methylation of HeLa cell nucleosome. NSD2 reaction mixtures containing 1 μM HeLaNuc, 100 nM NSD2, and 20 μM [Me-²H₃]-SAM in 50 mM Tris-HCl (pH 9.0) with 5 mM MgCl₂, 30 mM NaCl, 4 mM dithiothreitol, and 5% glycerol were monitored by LC-MS to track newly installed methyl marks.

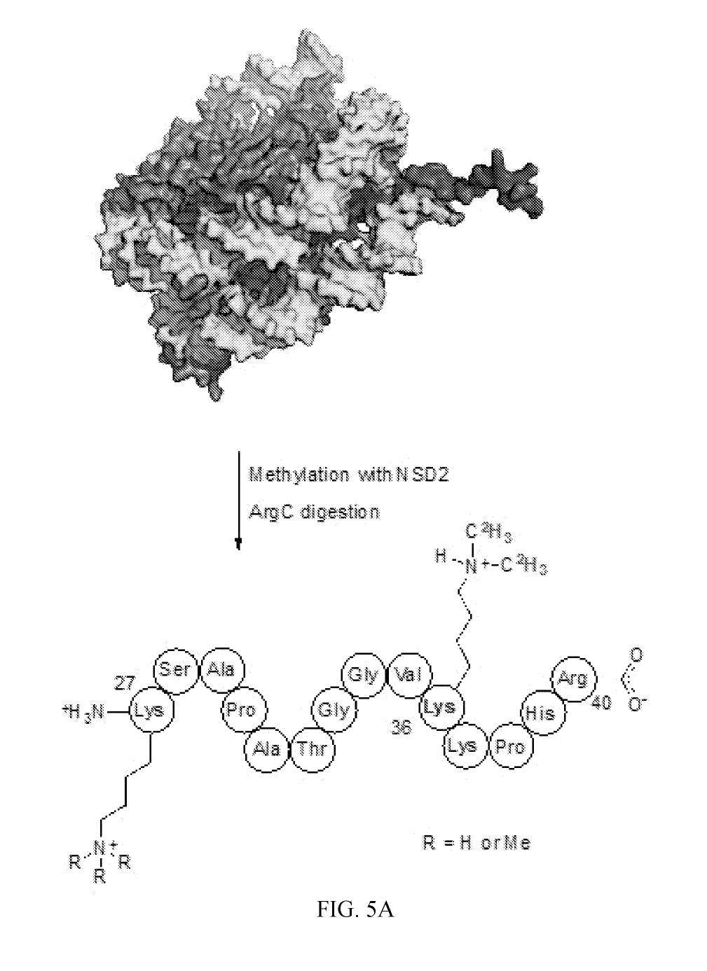

Synthesis of isotope labeled SAM [1′-³H]-, [5′-³H₂]-, and [5′-¹⁴C]-labeled ATPs were prepared as described previously (51). [8-¹⁴C]-ATP was synthesized enzymatically in an analogous manner using [8-¹⁴C]-labeled adenine (FIG. 5). [³⁶S]-methionine was prepared chemoenzymatically from [³⁶S]-sulfur as previously described (55). [1′-³H]-, [5-³H₂]-, [5′-¹⁴C]-, [8′-¹⁴C]-, [Me-³H₃]-, [Me-¹⁴C]-, [Me-²H₃]-, [Me-²H₃, 1′-³H]-, and [³⁶S, 8-¹⁴C]-labeled SAM were prepared using E. coli SAMSyn from the corresponding labeled ATPs or methionines (Table 1).

Measurement of KIEs and forward commitment. KIEs on V/K were measured using the competitive radiolabel approach (25, 51). SAM labeled at the atomic position of interest was mixed with an appropriate remote-labeled SAM bearing the light isotope at the position of interest shown in Table 2. KIEs were calculated from the change in isotope ratio in the remaining SAM substrate after 15-45% of the SAM substrate. Forward commitment (C_{f}) was measured using the isotope trapping method (28).

KIE measurements. KIEs were measured under competitive radiolabel conditions where the light substrate contained a remote 1′-³H or 8-¹⁴C to track the light isotope at the position of interest. For ³⁶S and Me-²H₃ KIEs the heavy substrate also contained a remote radiolabel to track the stable heavy isotope at the position of interest in the same way. The heavy and light substrates were mixed with a counts-per-minute (cpm) ratio for ³H:¹⁴C of approximately 1:1. Typical reactions contained 2.5 μM SAM (total of heavy, light and unlabeled), 1.5 μM HeLaNuc, and 10 nM NSD2 in 500 μL 50 mM Tris-HCl (pH 9.0) with 5 mM MgCl₂, 30 mM NaCl, 4 mM dithiothreitol, and 5% glycerol. A 250 μL portion of each mixture was removed to measure the isotope ratio of the unreacted substrate and immediately quenched by addition of 10 mM H₂SO₄. NSD2 was added to the remaining samples and allowed to proceed until 15-45% of the SAM was consumed (f=0.15-0.45). Reactions were quenched as above and frozen over dry ice to prevent SAM degradation before purification. Control reactions containing no HeLa nucleosome were run in parallel to control for SAM degradation during the incubation and purification procedure. SAM and SAH were isolated from each sample by analytical reversed-phase HPLC employing method B, where SAM and SAH elute at 5.5 and 15.5 min, respectively. The collected SAM and SAH fractions were dried by centrifugation under vacuum, dissolved in 500 μL of water and mixed with 10 mL of Ultima Gold scintillation fluid (PerkinElmer).

Samples were counted for radioactivity in a Tricarb 2910 TR scintillation counter (PerkinElmer) in dual-channel fashion where the ³H signal appears only in channel 1 and the ¹⁴C signal appears in both channels. The cpm per channel was determined from the average of 10 cycles of scintillation counting at 10 min per sample. The ratio of ¹⁴C cpm in channel 1:2 (r) was determined for standards containing only ¹⁴C-labeled SAM purified in an identical manner to the KIE reactions. The ³H and ¹⁴C signals were calculated by Eq. 2 and Eq. 3, respectively,

³H=CPM_{channel1}−(r×CPM_{channel2}) [2]

¹⁴C=CPM_{channel2}×(1+r) [3].

Experimental KIEs were calculated from the change of isotope ratio of the heavy to light isotopes of unreacted SAM initially (R₀) and at f=0.15-0.45 (R_{f}). The KIEs were extrapolated to 0% conversion using Eq. 4,

V/K=ln(1−f)/ln[(1−f)×(R_{f}/R₀)] [4]

where f is the fraction of conversion determined from the ratio of cpm from the remote label in the product SAH to the total cpm of remote label in both SAM and SAH. Each reported KIE is the average of at least six replicates measured from two independent experiments.

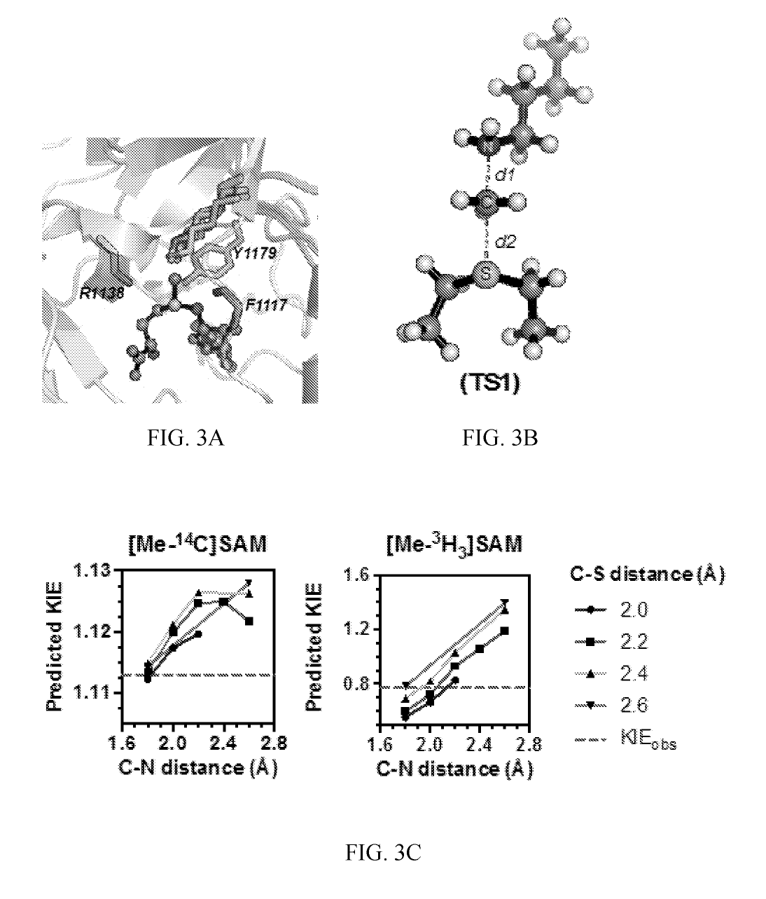

Measurement of Forward Commitment Factor. The forward commitment factor (C_{f}) for SAM was measured by isotope trapping (28). NSD2 (10 μM) was incubated for 5 min at 25° C. with [1′-³H] SAM (40 μM) in 50 mM Tris-HC1 (pH 9.0) with 5 mM MgCl₂, and 4 mM dithiothreitol allowing formation of an equilibrium enzyme-SAM complex (EA). A chase solution (480 μL; 1 mM unlabeled SAM, 2 μM HeLaNuc, 50 mM Tris-HCl (pH 9.0) with 5 mM MgCl₂, 4 mM dithiothreitol, 30 mM NaCl, and 5% glycerol) was rapidly mixed with 20 μL of the EA complex solution. Four 125 μL aliquots were removed and quenched with 10 mM H₂SO₄ at the indicated times in FIG. 3A. SAM and SAH were isolated for each time point as described for KIE measurement. Control reactions containing no HeLaNuc in the chase solution were used to correct for background levels of SAM breakdown. The ratio radiolabeled SAH produced to the initial concentration of EA complex was plotted as a function of time and extrapolated back to time zero. C_{f} was calculated using Eq. 5,

C_{f}=Y/(1−Y) [5]

where Y is the ratio of labeled SAH produced to initial ES complex at time zero. Intrinsic KIEs were obtained by correcting the observed KIEs (V/K) for forward commitment by Eq.1.

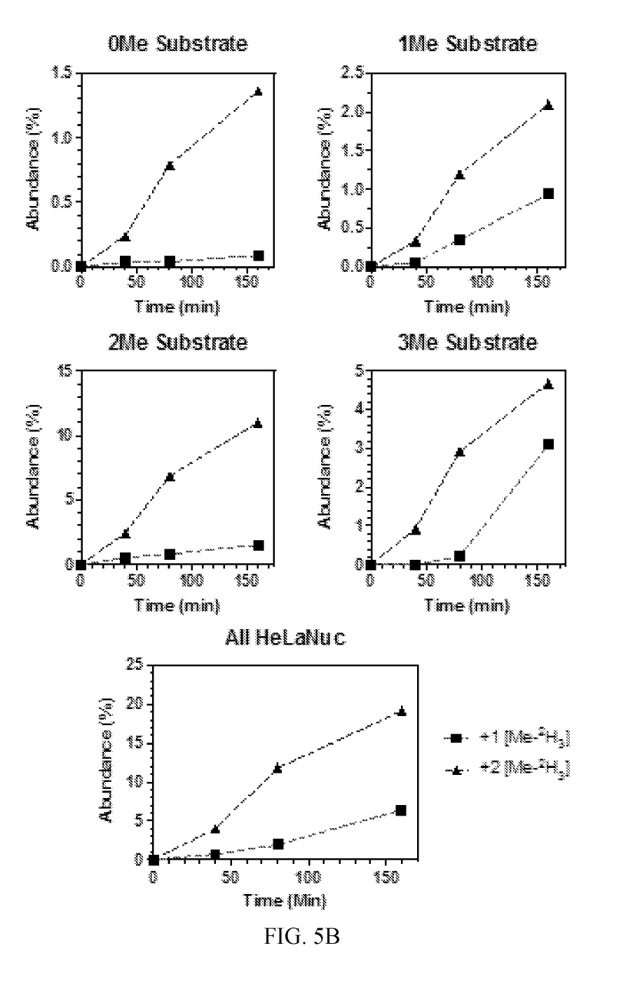

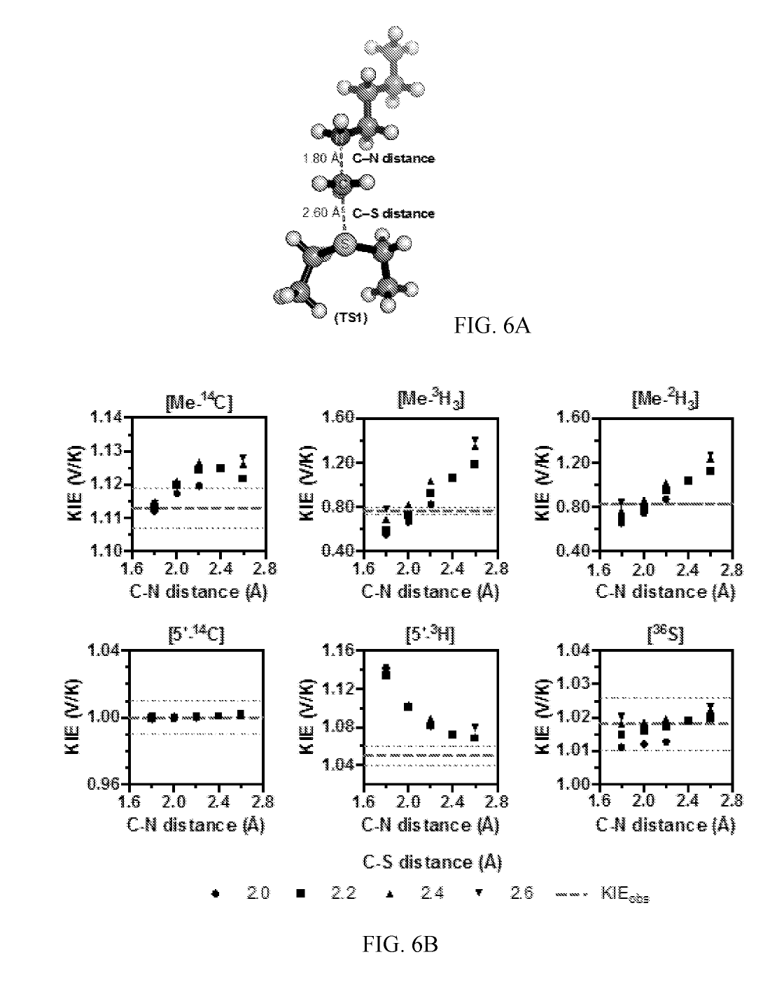

Computational methods. The TS for methyl transfer catalyzed by NSD2 was studied by density functional theory in m062X/6-31G* as implemented in Gaussian 09 (39). Starting coordinates for the TS were derived from an overlay of the crystal structures of NSD1 (PDB: 3OOI) (35), SET7/9 (PDB: 2F69 and 1XQH) (36), SET8 (PDB: 3F9Y and 3F9W) (FIG. 3) (37). Initial coordinates for TS1 were located at a first order saddle point and expanded to include d1 of 1.8, 2.0, 2.4 and 2.6 Å and d2 of 2.0, 2.2, 2.4 and 2.6 Å (FIG. 6). The same calculations were performed to locate the TS for the second methylation reaction (FIG. 7). Coordinates for the low energy conformation of SAM in the PubChem 3D database was used for the SAM ground states (GS) (56). SAM GS conformations were calculated at the same level of theory including water as an implicit solvent. The GS were located at local minima and contained no imaginary frequencies. A final TS model, including 40 atoms from active site residues derived from the crystal structure of NSD1 (3OOI) (35) was calculated at the m062X/6-31Gd* level of theory (TS2). These residues are conserved between NSD1 and NSD2. TS2 contains a single imaginary frequency corresponding to the methyl group transfer. KIEs for each TS structure were calculated from the scaled vibrational frequencies using ISOEFF98 with the appropriate GS structures.

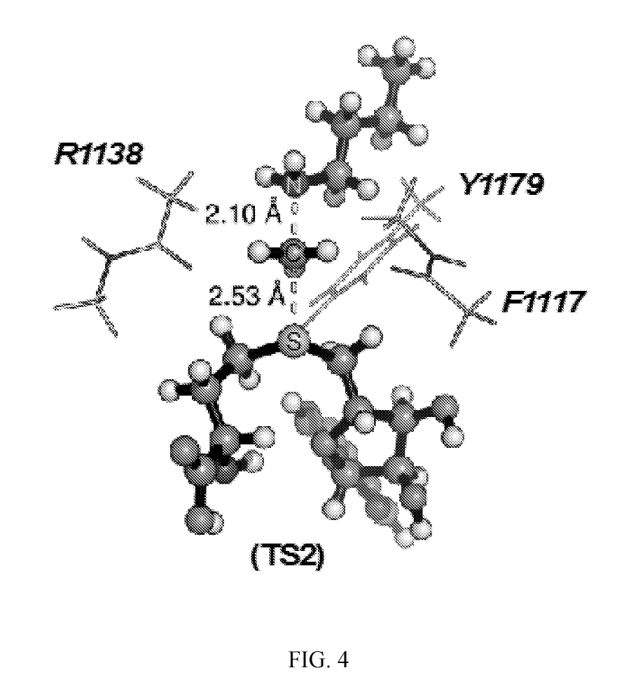

Natural bond orbital (NBO) analysis was performed for TS2 and the SAM (FIG. 4) using the same level of theory. Electrostatic potential maps for TS2 and bound SAM were visualized in Gaussview 5.0 using potential and density cubes generated from the NBO calculations (isovalue=0.04).

Synthesis of Isotopically labeled ATP. [5′-³H]ATP and [5′-¹⁴C]ATP were enzymatically synthesized and purified as previously described from [6′-³H]glucose and [6′-¹⁴C]glucose, respectively (51). Each reaction contained 0.5 mM glucose (combination of hot and cold), 2 mM adenine, 25 μM ATP, 20 mM MgCl₂, 5 mM NADP, 20 mM PEP, 50 mM KCl, 20 mM GlyGly, 100 mM KH₂PO₄ (pH 7.4), 1 U mL⁻¹ of HK, 5 U mL⁻¹ of MK, 1 U mL⁻¹ of G-6PD, 1 U mL⁻¹ of 6-PGD, 5 U mL⁻¹ of PRI, 10 U mL⁻¹ of PK, 5 U mL⁻¹ PRPPase, and 5 U mL⁻¹ of APRTase.

The synthesis of [1′-³H]ATP used [1′-³H]ribose as the labeled precursors. Each reaction contained 0.8 mM ribose (combination of hot and cold), 2 mM adenine, 0.1 mM ATP, 20 mM PEP, 10 mM MgCl₂, 100 mM KH₂PO₄ (pH 7.4), with 5 U mL⁻¹ of RK, 2 U mL⁻¹ of MK, 10 U mL⁻¹ of PK, 5 U mL⁻¹ PRPPase, and 2 U mL⁻¹ of ARPTase.

[8-¹⁴C]ATP was prepared from [8-¹⁴C]adenine enzymatically. Reactions consisted of 1 mM adenine (total of hot and cold), 2.4 mM PRPP, 0.1 mM ATP, 20 mM PEP, 10 mM MgCl₂, 100 mM KH₂PO₄ (pH 7.4), with 2 U mL⁻¹ of MK, 20 U mL⁻¹ PK, and 2 U mL⁻¹ of APRTase.

Synthesis and purification of isotope labeled SAM. Labeled SAM were prepared using E. coli SAMSyn from the corresponding labeled ATPs or methionines (Table 1). Typical reactions contained 1 mM methionine, 1 mM ATP, and 800 nM MAT in 500 ,μL of 20 mM Tris-HCl, pH 8.0 containing 25 mM MgSO₄, 50 mM K₂50₄, and 8% β-mercaptoethanol, and were incubated at 37° C. for 2-3 hours. For radiolabeled methionine 50 μCi of labeled methionine was diluted to 1 mM using cold methionine. Radiolabeled ATPs were diluted to 1 mM with cold ATP in a similar manner. Labeled SAMs were purified by reverse-phase high performance liquid chromatography (HPLC) using water with 0.1% formic acid for 4 min followed by a linear gradient of 0-45% acetonitrile over 6 min and holding at 45% acetonitrile for 10 min before re-equilibrating (HPLC method A). SAM elutes at 3 min under these conditions. The isolated SAMs were dried by centrifugation under vacuum and further purified by reverse-phase HPLC using 50 mM ammonium formate pH 4 for 4 min followed by a linear gradient of 0-30% acetonitrile in the same buffer over 8 min holding at 30% acetonitrile for 8 min (HPLC method B). All labeled SAMs co-elute with authentic SAM. Using this method labeled SAMs were isolated as a single isomer (S,S) in greater than 95% purity.

Expression and Purification of apoWSET(980-1365). Full-length (fl) human NSD2 cDNA was PCR amplified from the cDNA library of a human breast cancer cell line (using Kozak-adapted 5′ gene-specific primer and 3′ gene-specific primer) and the PCR product was cloned into pENTR/TEV/D-TOPO vector. NSD2(980-1365) was generated from NSD2(full length) cDNA with Tev sequence at 5 prime end and put into pDONR221. An LR reaction was performed between pDEST8HisGSTv2 vector and pDONR221-TevNSD2(980-1365) construct to generate a Baculovirus expression construct pDESTHisGSTv2-TevNSD2(980-1365). Baculovirus expressing HisGST-TevNSD2(980-1365) was generated by transforming the construct into DH10Bac cells via a Bac-to-Bac system. The virus was amplified and protein was expressed in SF9 cells. All protein purification steps were carried out at 4° C. HisGST-TevNSD2(980-1365) was released from baculoviral infected SF9 cells by sonication and captured by batch adsorption onto Glutathione Sepharose 4B (GE Healthcare) from clarified cell lysate supernatant. NSD2(980-1365) was released by overnight on column cleavage with tobacco etch virus protease (TEV 6His-protease S216V). Cofactor S-adenosylmethionine (SAM) was removed from NSD2(980-1365) by capture onto Mono S in 2 M Urea at pH=7. After extensive washing with 1.5 M Urea, MMSET(980-1365) was eluted with an increasing linear salt and decreasing Urea gradients. The Mono S pool was concentrated and further fractionated on Superdex 200. Removal of SAM was confirmed by heat precipitation of NSD2(980-1365) for 20 min at 55° C. and the SAM concentration was measured by absorbance at 260 nm in the supernatant (modified method from (57)). After unfolding and refolding the activity of apo NSD2(980-1365) demonstrated equivalent specific activity as the initial SAM-bound NSD2(980-1365) against HeLaNuc.

LC-MS analysis of HeLaNuc products. Reactions of NSD2 (100 nM) with HeLaNuc (2 μM) and [Me-²H₃]SAM (20 μM) in 500 μL 50 mM Tris-HC1 (pH 9.0) with 5 mM MgCl₂, 30 mM NaCl, 4 mM dithiothreitol, and 5% glycerol were allowed to proceed for 0, 40, 80 and 160 min and stopped with 0.5% formic acid. A 10 μL volume of each sample, containing approximately 1.2 μg of H3 protein, was removed and diluted with 20 μL of buffer containing 100 mM ammonium bicarbonate and 5 mM calcium acetate. 5 μL of 45 mM DTT solution was added to each sample followed by 2.5 μL (125 ng) of ArgC (Protea Biosciences) solution. The samples were allowed to digest at 37° C. over 2.5 h and then stopped by adding 1 μL of formic acid to each sample. Duplicate samples were prepared for each time point and analyzed by LC-MS on an LTQ-Orbitrap Velos Pro equipped with an Agilent 1100 nano-HPLC system. Methylated products were observed for the peptide containing amino acids 27-40 of histone H3. The approximate distribution of each product was calculated on the basis of their ion abundance.

### Results and Discussion

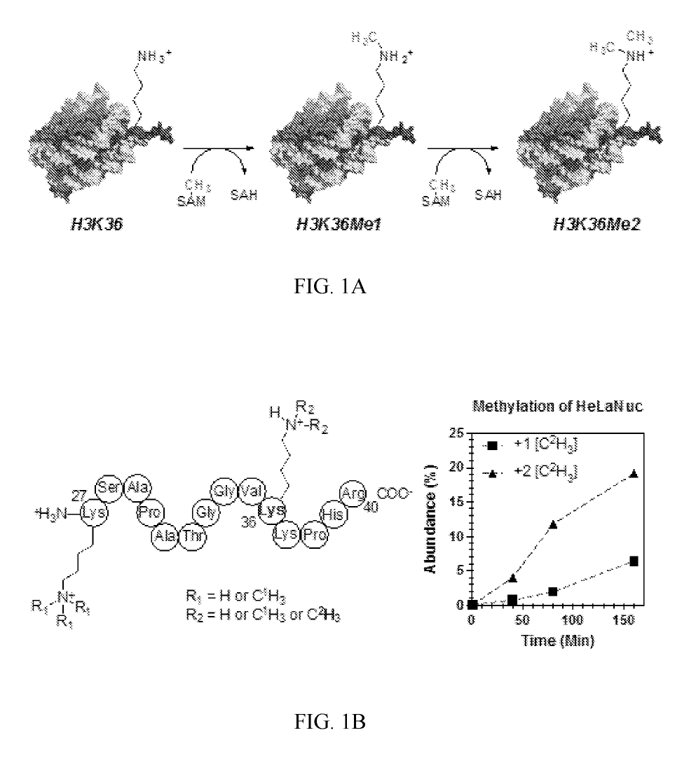

NSD2 di-methylates histone H3 at lysine 36 of HeLa cell nucleosomes. The substrate and product specificity of NSD2 is dependent on both the nature of the substrate and the NSD2 construct used (17, 18). The product distribution was analyzed using extracted HeLaNuc as a mimic of the native substrate and a NSD2 construct containing the C-terminal SET domain and basic post-SET extensions (residues 980-1365). HeLaNuc contain a heterogeneous mixture of preexisting methyl marks (26). The installation of new methyl marks was tracked using [Me-²H₃]-SAM and the products monitored by LC-MS after protease digestion (FIG. 1). Under these conditions, only mono- and dimethylation of histone H3K36 were observed regardless of the pre-existing methylation state present in the parent nucleosome, consistent with previous reports of wild type NSD2 specificity (FIG. 5) (11, 17). No trimethylated H3K36 was observed, consistent with reports that SETD2 is the only known human H3 K36 trimethyltransferase (27). These results indicate the specificity of the NSD2 construct was not altered by truncation of the N-terminal domains. These results indicate that the N-terminal domains of NSD2 do not directly affect the enzyme chemistry and are unlikely to alter the TS structure.

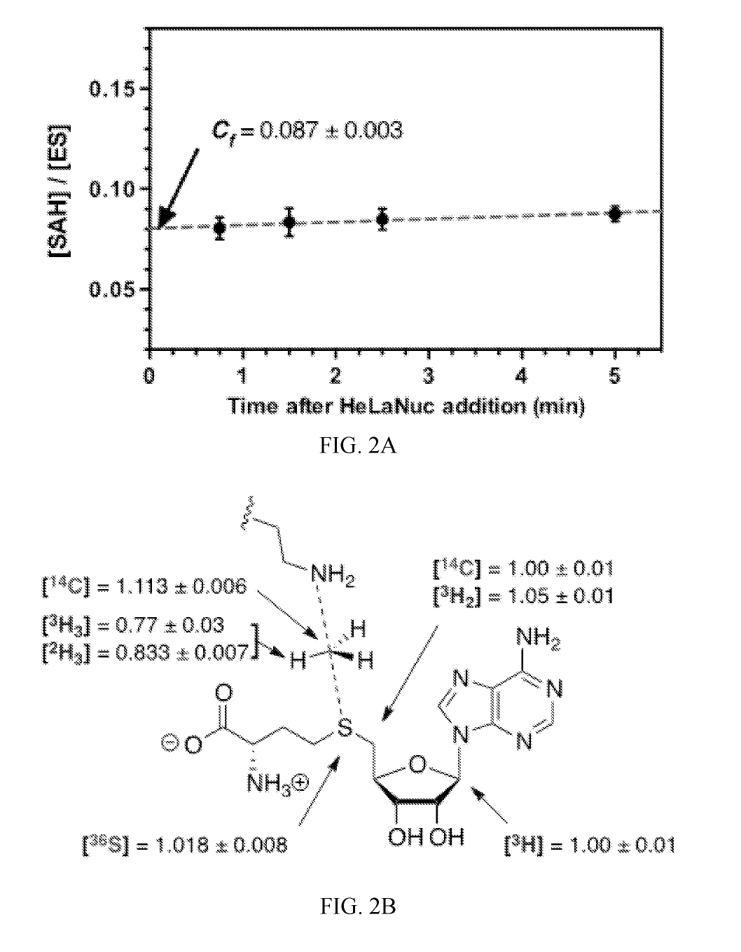

Measurement of intrinsic KIEs and forward commitment. KIEs for methylation of HeLaNuc histone H3K36 by NSD2 were measured using a competitive radiolabel approach. Under these conditions the observed KIEs on Vₘₐₓ/Kₘ (V/K) include contributions from all isotopically sensitive steps up to and including the first irreversible reaction, which for PKMT is generally accepted to be CH₃-transfer (5). Thus any events preceding CH₃-transfer, including substrate binding and lysine deprotonation, can lead to an observed forward commitment (C_{f}), which would lower the magnitude of measured KIEs. C_{f} is a measure of the distribution of enzyme bound substrate that proceeds to form product rather than equilibrate with free substrate. Using the isotope trapping method (28), a C_{f} of 0.087±0.003 was measured for the reaction of SAM with NSD2_{SET} (FIG. 2A). This C_{f} is relatively low indicating that events preceding CH₃-transfer are not significantly rate limiting, and Eq. 1 can be used to obtain intrinsic KIEs (k) required for TS analysis, where (V/K) is the observed KIE,

(V/K)=(k=C_{f})/(1+C_{f}) [1].

KIEs measured for the atomic positions surrounding the methyltransfer reaction coordinate are summarized in Table 2 and FIG. 2B. Each KIE was determined under competitive conditions using a ‘heavy’ substrate, bearing a ³H or ¹⁴C at the position of interest, and a ‘light’ substrate with a remote radiolabel reporting on the corresponding light isotope at the position of interest. For [Me-²H₃] and [³⁶S] the heavy substrates also contained a remote [1′-³H] or [8-¹⁴C] label. KIEs were determined from the change of isotope ratio of the unreacted SAM after 15-45% had been consumed. Correcting for C_{f} gave an intrinsic primary [Me-¹⁴C] KIE of 1.113±0.006, primary [³⁶S] KIE of 1.018±0.008 and secondary [Me-³H₃], [⁵′-¹⁴C], and [5′-³H₂] KIEs of 0.77±0.03, 1.00±0.01, and 1.05±0.01, respectively.

A large primary ¹⁴C KIE is consistent with an S_{N}2 mechanism where the CH₃-transfer is largely rate limiting. The magnitude of the primary KIE of the transferring methyl-group for S_{N}2 reaction mechanisms is proportional to the symmetry of the TS structure, with the largest isotope effects expected when bond order to the nucleophile and leaving group are equal (29). A large inverse α-secondary ³H KIE for the methyl group hydrogen of 0.77±0.03 suggests the hydrogen vibrational modes are constrained at the TS relative to the ground state. To confirm the magnitude of this isotope effect, the α-secondary [Me-²H₃] KIE was measured as well. The intrinsic [Me-²H₃] KIE of 0.833±0.007 is in good agreement with the [Me-³H₃] isotope effect given the difference in the reduced mass of each isotope (30). Such large inverse α-secondary KIEs have previously been observed for the methylation of catechol substrates by catechol O-methyltransferase (COMT) (31, 32). In that case the large inverse KIE was attributed to compression of the methyl donor-acceptor distance at the transition state (31). However, QM/MM calculations suggest that such compression is not required to explain the observed inverse KIEs (33, 34).

Computational models of the NSD2 TS. The TS structure for methylation of H3K36 by NSD2 was modeled using the intrinsic KIEs as constraints. An input for TS analysis was derived from the conformation of SAM in the crystal structure of NSD1 (PDB: 3OOI) (35) as no structure of NSD2 was available. The catalytic SET domain of NSD1 and NSD2 are highly homologous containing 79% sequence identity. To model the lysine position, the SET domain of NSD1 was overlaid with those of SET7/9, SET8 and PIMS bound to their corresponding peptide substrates (FIG. 3A) (36-38). The average lysine geometry was used to generate a simplified TS model (TS1 in FIG. 3B).

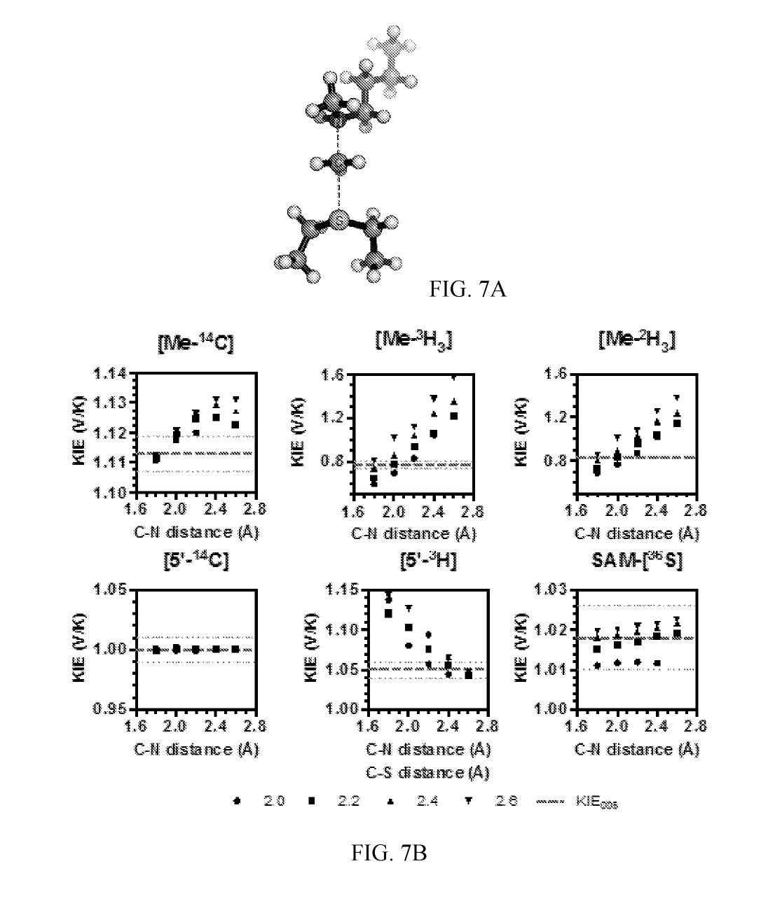

The TS geometry for NSD2 can be described by a combination of the C—N and C—S distances, d1 and d2, shown in FIG. 3B. A series of TS structures with fixed d1 and d2 distances was calculated at the m062x/6-31G* level of theory, as implemented in Gaussian 09 (39). No other constraints on the transition state geometry or the S—C—N bond angle were imposed. Theoretical isotope effects for each geometry were predicted from the scaled vibrational frequencies using the program ISOEFF98 (FIG. 3C, FIG. 6) (40). Since NSD2 catalyzes both the mono and di-methylation of H3K36, the observed KIEs could arise from the TS for either the first or second methylation reaction or a combination of the two. The same calculations were performed using a TS model for the second methylation reaction (FIG. 7). TS models for both the first and second methylation reaction catalyzed by NSD2 had highly similar predicted KIEs for all geometries tested, so for the sake of simplicity the discussion is focused on the TS for the first methylation. In general, the predicted Me-¹⁴C KIEs were larger (>1.12) for TS geometries with more symmetrical bond order to both the sulfur leaving group and nitrogen nucleophile, with a later, asymmetric TS matching the observed KIE of 1.113 (FIG. 3C). A number of TS geometries with compressed donor-acceptor distances predict inverse Me-³H₃ KIEs but gave poor agreement with the Me-¹⁴C ME. Instead, the predicted Me-³H₃ KIEs matched most optimally to TS geometries with greater bond order to the lysine nitrogen. Predicted ³⁶S KIEs are also consistent for a product-like TS geometry with substantial loss of bond order to the transferring CH₃ group at the TS. The closest match to all intrinsic KIEs was observed with d1 and d2 fixed at 1.8 Å and 2.6 Å, respectively, corresponding to a late product-like TS geometry; however, no TS geometry was able to reproduce the observed 5′-³H₂ KIE (FIG. 6, 7). This KIE is highly dependent on the bound SAM geometry and was found to vary substantially as the result of rotation around the C5′—S bond in the simplified TS model (FIG. 8).

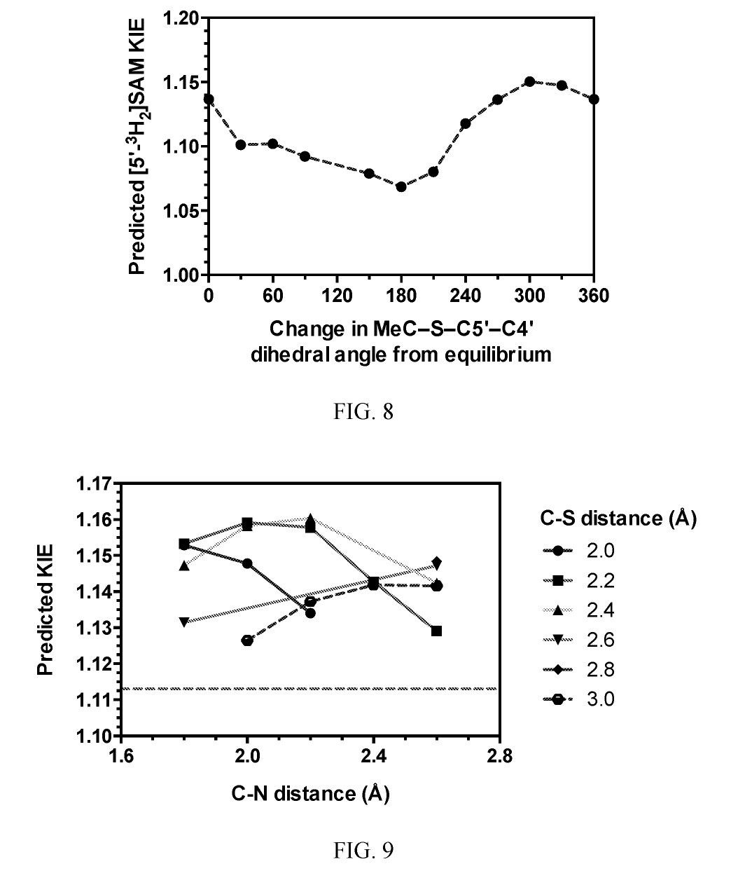

Previous work indicates quantum mechanical (QM) tunneling can contribute to the magnitude of heavy atom KIEs (41, 42). To assess the possibility that QM tunneling contributes to the observed Me-¹⁴C KIE, predicted Me-¹⁴C KIEs were calculated while including a correction for carbon tunneling. For the present system, the magnitude of predicted KIEs including tunneling are larger than the intrinsic value for all TS geometries tested (FIG. 9) and, as a result, a tunneling correction was not included in the final TS predictions.

Secondary hydrogen KIEs can also be influenced by geometric and electronic constraints imposed by the enzyme that are not reproduced using a simplified TS model. Previous QM/MM studies of COMT have shown that increasing the number of atoms included in the QM region impacts the predicted donor-acceptor geometry in the bound complex of COMT, SAM and catechol (43). Thus, it is possible that including atoms from amino acids from NSD2 active site residues in the QM calculation will influence the predicted KIEs. Here, the backbone carbonyls of R1138 and F1117 and side chain of Y1179, whose positions are conserved amongst SET domain containing PKMT, were included in the TS calculation (FIG. 4) (44). The corresponding residues in SET7/9 are proposed to interact with the hydrogen atoms on the transferring methyl group (44, 45). Including these interactions in the model, a match was observed to all intrinsic KIEs with d2 fixed at 2.53 Å and d1 at 2.10 Å (TS2 in FIG. 4). The predicted [Me-³H₃], [Me-²H₃] and [5′-³H₂] KIEs were more inverse, or less normal, than those observed for a simplified TS model (TS1) with the same geometry indicating the Me-H₃ and 5′-H₂ bond vibrational modes are more constrained in the presence of these active site interactions. However, there is no evidence that the donor-acceptor distance is compressed in the transition state model and the intrinsic KIEs for NSD2 are consistent with product-like TS models with a shorter bond to the nucleophilic nitrogen. The total donor-acceptor distance in this model is in good agreement with previous QM/MM calculation for related PKMT that predict a range of possible TS geometries (22, 23, 46-49). Compared to the TS geometry calculated for other human PKMT, the TS for NSD2 is more product-like, having a more dissociated C—S bond. This may allow for the design of NSD2 specific inhibitors that mimic this product-like TS geometry.

TS bond order and charge distribution. The total bond order to both the leaving group and nucleophile in an S_{N}2 reaction can vary between 0, for extremely loose TS, up to 2 for highly compact TS geometry. By comparison, TS2 has calculated bond orders of 0.382 and 0.482 for the C—S and C—N bonds, respectively. The sum of these bond orders is consistent with a loose donor-acceptor distance in the NSD2 TS structure. The electrostatic potential and natural bond orbital (NBO) charge distribution in TS2 was compared to that of SAM and the methyltransferase inhibitor sinefungin. A positive charge is predominantly localized on the sulfur atom of SAM in GS2, as indicated by the NBO charge of 0.930 for the sulfur atom compared to 0.024 for the Me group carbon and hydrogen. In TS2 the positive charge on sulfur is reduced to 0.398 with a corresponding increase for the Me group to 0.326, consistent with an S_{N}2 TS where the positive charge is distributed between the leaving group, transferring group and nucleophile. The same distribution is observed for the electrostatic potential, where a positive electrostatic potential is localized on sulfur in SAM and distributed between the sulfur, methyl carbon and lysine nitrogen in TS2. Analogues of sinefungin have been reported as selective inhibitors of SETD2, and proposed to mimic the TS of this enzyme (50). However, the electrostatic potential distribution for sinefungin appears to more closely mimic the charge localization of SAM than TS2. It is likely that chemically stable analogues of the NSD2 TS will require that a positive charge be distributed between at least two atoms and located at least 2.5 Å from a neutral atom mimicking the leaving group sulfur.

### CONCLUSIONS

Epigenetic control by methylation of histones is essential in development. Loss of regulation of methylation pathways is involved in developmental disorders and oncogenesis. Despite interest in NSD2, there have been no selective inhibitors reported. Analogues designed to mimic the NSD2 transition state structure are potential enzyme inhibitors. A combination of experimental kinetic isotope effects and quantum chemistry was used to define the sub-A details of reaction chemistry at the transition state of NSD2. Electrostatic potential maps of reactants and transition states provide a high-resolution map of reaction chemistry and a blueprint for design of transition state analogues for this mechanism of epigenetic regulation.

NSD2 predominantly catalyzes the dimethylation of HeLaNuc on H3K36 in vitro, consistent with the activity of full length NSD2 (11, 17). Using a combination of experimental KIE measurements and DFT calculations, a TS structure was determined for the NSD2 SET domain catalyzed methylation of histone H3K36. The intrinsic KIEs are consistent with an S_{N}2 reaction mechanism where methyl group transfer is significantly rate limiting. All of the intrinsic KIEs are consistent with a product like TS geometry with a longer leaving group distance and shorter nucleophile distances of 2.53 Å and 2.10 Å, respectively. A comparison of electrostatic potential for the predicted TS structure and SAM GS indicate the positive charge on SAM is distributed between the leaving group sulfur, the transferring methyl group and the nitrogen nucleophile at the TS. This geometry and charge distribution can now guide future transition state analogue design for inhibitors of NSD2.

TABLE 1
Synthesis of isotopically labeled SAM from labeled ATP and Met.

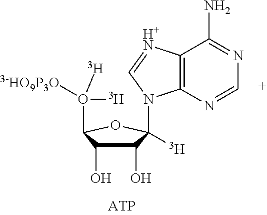

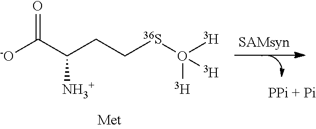

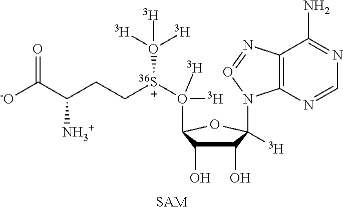

| Labeled SAM product | ATP substrate | Met substrate |
|---|---|---|
| [Me—¹⁴C] | — | [Me—¹⁴C] |
| [Me—³H₃] | — | [Me—³H₃] |
| [Me—²H₃, 1′-³H] | [1′-³H] | [Me—²H₃] |
| [Me—²H₃] | — | [Me—²H₃] |
| [5′-¹⁴C] | [5′-¹⁴C] | — |
| [5′-³H₂] | [5′-³H₂] | — |
| [³⁶S, 8-¹⁴C] | [8-¹⁴C] | [³⁶S] |
| [8-¹⁴C] | [8-¹⁴C] | — |
| [1′-³H] | [1′-³H] | — |

— denotes unlabeled ATP or Met was used

TABLE 2
Summary of experimental and predicted KIEs for
H3 K36 methylation catalyzed by NSD2.

| SAM substrates | | observed | | predicted KIEs | |
|---|---|---|---|---|---|
| heavy | light | (V/K)KIEs^{a} | intrinsic KlEs^{b} | (TS1)^{c} | (TS2) |
| [Me—¹⁴C] | [1′-³H] | 1.105 ± 0.004 | 1.113 ± 0.006 | 1.114 | 1.118 |
| [Me—³H₃] | [8-¹⁴C] | 0.79 ± 0.03 | 0.77 ± 0.03 | 0.783 | 0.768 |
| [Me—²H₃, | [8-¹⁴C] | 0.845 ± 0.006 | 0.833 ± 0.007 | 0.839 | 0.826 |
| 1′-³H] | | | | | |
| [5′-¹⁴C] | [1′-³H] | 0.995 ± 0.009 | 1.00 ± 0.01 | 1.001 | 1.004 |
| [5′-³H₂] | [8-¹⁴C] | 1.05 ± 0.01 | 1.05 ± 0.01 | 1.137 | 1.057 |
| [³⁶S, 8-¹⁴C] | [1′-³H] | 1.017 ± 0.007 | 1.018 ± 0.008 | 1.020 | 1.022 |
| [1′-³H] | [8-¹⁴C] | 1.00 ± 0.01 | 1.00 ± 0.01 | | |

^{a}Observed KIE are reported as the mean ± standard deviation from at least six replicates from two independent experiments.
^{b}Intrinsic KIEs are calculated from observed (V/K)KIEs by correcting for a C_{f} = 0.087 ± 0.003.
^{c}Predicted KIEs for TS1 (FIG. 3B)best matching intrinsic KIEs with d1 = 1.8 Å and d2 = 2.6 Å.

### REFERENCES

1. Kouzarides T (2007) Chromatin modifications and their function. Cell 128(4):693-705.

2. Jenuwein T & Allis CD (2001) Translating the Histone Code. Science 293(5532):1074-1080.

3. Dillon S C, Zhang X, Trievel R C, & Cheng X (2005) The SET-domain protein superfamily: protein lysine methyltransferases. Genome Biol. 6(8):227.

4. Zhang X & Bruice T C (2008) Enzymatic mechanism and product specificity of SET-domain protein lysine methyltransferases. Proc. Natl. Acad. Sci. U S. A. 105(15):5728-5732.

5. Kipp D R, Quinn C M, & Fortin P D (2013) Enzyme-dependent lysine deprotonation in EZH2 catalysis. Biochemistry 52(39):6866-6878.

6. Cao R, et al. (2002) Role of histone H3 lysine 27 methylation in Polycomb-group silencing. Science 298(5595):1039-1043.

7. Wozniak G G & Strahl B D (2014) Hitting the ‘mark’: interpreting lysine methylation in the context of active transcription. Biochim. Biophys. Acta 1839(12):1353-1361.

8. Schneider R, Bannister A J, & Kouzarides T (2002) Unsafe SETs: histone lysine methyltransferases and cancer. Trends Biochem. Sci. 27(8):396-402.

9. Stec I, et al. (1998) WHSC1, a 90 kb SET domain-containing gene, expressed in early development and homologous to a Drosophila dysmorphy gene maps in the Wolf-Hirschhorn syndrome critical region and is fused to IgH in t(4;14) multiple myeloma. Hum. Mol. Genet. 7(7):1071-1082.

10. Chesi M, et al. (1998) The t(4;14) translocation in myeloma dysregulates both FGFR3 and a novel gene, MMSET, resulting in IgH/MMSET hybrid transcripts. Blood 92(9):3025-3034.

11. Kuo A J, et al. (2011) NSD2 links dimethylation of histone H3 at lysine 36 to oncogenic programming. Mol. Cell 44(4): 609-620.

12. Morishita M & di Luccio E (2011) Cancers and the NSD family of histone lysine methyltransferases. Biochimica Et Biophysica Acta-Reviews on Cancer 1816(2): 158-163.

13. Hudlebusch H R, et al. (2011) MMSET Is Highly Expressed and Associated with Aggressiveness in Neuroblastoma. Cancer Res. 71(12):4226-4235.

14. Morishita M, Mevius D, & di Luccio E (2014) In vitro histone lysine methylation by NSD1, NSD2/MMSET/WHSC1, and NSD3/WHSC1L. BMC Struct. Biol. 14(1):25.

15. Nimura K, et al. (2009) A histone H3 lysine 36 trimethyltransferase links Nkx2-5 to Wolf-Hirschhorn syndrome. Nature 460(7252):287-291.

16. Pei H, et al. (2011) MMSET regulates histone H4K20 methylation and 53BP1 accumulation at DNA damage sites. Nature 470(7332):124-128.

17. Li Y, et al. (2009) The Target of the NSD Family of Histone Lysine Methyltransferases Depends on the Nature of the Substrate. J. Biol. Chem. 284(49):34283-34295.

18. Allali-Hassani A, et al. (2014) A Basic Post-SET Extension of NSDs Is Essential for Nucleosome Binding In Vitro. J. Biomol. Screen. 19(6):928-935.

19. Kuo A J, et al. (2011) NSD2 Links Dimethylation of Histone H3 at Lysine 36 to Oncogenic Programming. Mol. Cell 44(4):609-620.

20. Schramm V L (2007) Enzymatic transition state theory and transition state analogue design. J. Biol. Chem. 282(39):28297-28300.

21. Schramm V L (2011) Enzymatic Transition States, Transition-State Analogs, Dynamics, Thermodynamics, and Lifetimes. Annual Review of Biochemistry, Vol 80 80:703-732.

22. Zhang X & Bruice T C (2008) Product specificity and mechanism of protein lysine methyltransferases: insights from the histone lysine methyltransferase SET8. Biochemistry 47(25):6671-6677.

23. Zhang X & Bruice T C (2007) Histone lysine methyltransferase SET7/9: formation of a water channel precedes each methyl transfer. Biochemistry 46(51):14838-14844.

24. Cleland W W (1995) Isotope effects: determination of enzyme transition state structure. Methods Enzymol. 249:341-373.

25. Schramm V L (1999) Enzymatic transition-state analysis and transition-state analogs. Methods Enzymol. 308:301-355.

26. Young N L, et al. (2009) High Throughput Characterization of Combinatorial Histone Codes. Mol. Cell. Proteomics 8(10):2266-2284.

27. Wagner E J & Carpenter P B (2012) Understanding the language of Lys36 methylation at histone H3. Nat. Rev. Mol. Cell Biol. 13(2):115-126.

28. Rose I A (1980) The isotope trapping method: desorption rates of productive E.S complexes. Methods Enzymol. 64:47-59.

29. Westaway K C (2006) Using kinetic isotope effects to determine the structure of the transition states of SN2 reactions. Adv. Phys. Org. Chem., ed Richard J P (Academic Press), Vol Volume 41, pp 217-273.

30. Swain C G, Stivers E C, Reuwer J F, & Schaad L J (1958) Use of Hydrogen Isotope Effects to Identify the Attacking Nucleophile in the Enolization of Ketones Catalyzed by Acetic Acid1-3. J. Am. Chem. Soc. 80(21):5885-5893.

31. Hegazi M, F., Borchardt R, T., & Schowen R, L. (1979) alpha-Deuterium and Carbon-13 Isotope Effects for Methyl Transfer Catalyzed by Catechol O-Methyltransferase. SN2—Like transition State. J. Am. Chem. Soc. 101(15):4359-4365.

32. Zhang J & Klinman J P (2011) Enzymatic methyl transfer: role of an active site residue in generating active site compaction that correlates with catalytic efficiency. J. Am. Chem. Soc. 133(43):17134-17137.

33. Ruggiero G D, Williams I H, Roca M, Moliner V, & Tunon I (2004) QM/MM determination of kinetic isotope effects for COMT-catalyzed methyl transfer does not support compression hypothesis. J. Am. Chem. Soc. 126(28):8634-8635.

34. Lameira J, Bora R P, Chu Z T, & Warshel A (2015) Methyltransferases do not work by compression, cratic, or desolvation effects, but by electrostatic preorganization. Proteins 83(2):318-330.

35. Qiao Q, et al. (2011) The structure of NSD1 reveals an autoregulatory mechanism underlying histone H3K36 methylation. J. Biol. Chem. 286(10):8361-8368.

36. Couture J F, Collazo E, Hauk G, & Trievel R C (2006) Structural basis for the methylation site specificity of SET7/9. Nat. Struct. Mol. Biol. 13(2):140-146.

37. Couture J F, Dirk L M, Brunzelle J S, Houtz R L, & Trievel R C (2008) Structural origins for the product specificity of SET domain protein methyltransferases. Proc. Natl. Acad. Sci. U S. A. 105(52):20659-20664.

38. Zhang X, et al. (2003) Structural basis for the product specificity of histone lysine methyltransferases. Mol. Cell 12(1): 177-185.

39. Frisch M J, et al. (2009) Gaussian 09 (Gaussian, Inc., Wallingford, Conn., USA).

40. Anisimov V & Paneth P (1999) ISOEFF98. A program for studies of isotope effects using Hessian modifications. J. Math. Chem. 26(1-3):75-86.

41. Gonzalez-James O M, et al. (2010) Experimental evidence for heavy-atom tunneling in the ring-opening of cyclopropylcarbinyl radical from intramolecular 12C/13C kinetic isotope effects. J. Am. Chem. Soc. 132(36):12548-12549.

42. Vetticatt M J & Singleton D A (2012) Isotope effects and heavy-atom tunneling in the

Roush allylboration of aldehydes. Org. Lett. 14(9):2370-2373.

43. Zhang J, Kulik H J, Martinez T J, & Klinman J P (2015) Mediation of donor-acceptor distance in an enzymatic methyl transfer reaction. Proc. Natl. Acad. Sci. U S. A. 112(26):7954-7959.

44. Horowitz S, et al. (2013) Conservation and functional importance of carbon-oxygen hydrogen bonding in AdoMet-dependent methyltransferases. J. Am. Chem. Soc. 135(41):15536-15548.

45. Horowitz S, Yesselman J D, Al-Hashimi H M, & Trievel R C (2011) Direct evidence for methyl group coordination by carbon-oxygen hydrogen bonds in the lysine methyltransferase SET7/9. J. Biol. Chem. 286(21):18658-18663.

46. Hu P & Zhang Y (2006) Catalytic Mechanism and Product Specificity of the Histone Lysine Methyltransferase SET7/9: An ab Initio QM/MM-FE Study with Multiple Initial Structures. J. Am. Chem. Soc. 128(4):1272-1278.

47. Zhang X & Bruice T C (2007) A quantum mechanics/molecular mechanics study of the catalytic mechanism and product specificity of viral histone lysine methyltransferase. Biochemistry 46(34):9743-9751.

48. Zhang X & Bruice T C (2007) Catalytic mechanism and product specificity of rubisco large subunit methyltransferase: QM/MM and MD investigations. Biochemistry 46(18):5505-5514.

49. Zhang X & Bruice T C (2008) Mechanism of product specificity of AdoMet methylation catalyzed by lysine methyltransferases: transcriptional factor p53 methylation by histone lysine methyltransferase SET7/9. Biochemistry 47(9):2743-2748.

50. Zheng W, et al. (2012) Sinefungin Derivatives as Inhibitors and Structure Probes of Protein Lysine Methyltransferase SETD2. J. Am. Chem. Soc. 134(43):18004-18014.

51. Parkin D W, Leung H B, & Schramm V L (1984) Synthesis of nucleotides with specific radiolabels in ribose. Primary 14C and secondary 3H kinetic isotope effects on acid-catalyzed glycosidic bond hydrolysis of AMP, dAMP, and inosine. J. Biol. Chem. 259(15):9411-9417.

52. Singh V, Lee J E, Núñez S, Howell P L, & Schramm V L (2005) Transition State Structure of 5′ -Methylthioadenosine/S-Adenosylhomocysteine Nucleosidase from Escherichia coli and Its Similarity to Transition State Analogues\. Biochemistry 44(35):11647-11659.

53. Markham G D, Hafner E W, Tabor C W, & Tabor H (1980) S-Adenosylmethionine synthetase from Escherichia coli. I Biol. Chem. 255(19):9082-9092.

54. Jiang Y, et al. (2011) Methyltransferases prefer monomer over core-trimmed nucleosomes as in vitro substrates. Anal. Biochem. 415(1):84-86.

55. Poulin M B, Du Q, & Schramm V L (2015) Chemoenzymatic synthesis of 36S isotopologues of methionine and S-adenosyl-L-methionine. J. Org. Chem. 80(10):5344-5347.

56. Kim S, Bolton E E, & Bryant S H (2013) PubChem3D: conformer ensemble accuracy. J. cheminformatics 5(1): 1.

57. Forneris F, Binda C, Vanoni M A, Mattevi A, & Battaglioli E (2005) Histone demethylation catalysed by LSD1 is a flavin-dependent oxidative process. FEBS Lett. 579(10):2203-2207.

58. Bagdassarian, C. K., Schramm, V. L., and Schwartz, S. D. (1996) Molecular electrostatic potential analysis for enzymatic substrates, competitive inhibitors and transition-state inhibitors, J. Am. Chem. Soc. 118, 8825-8836.

59. U.S. Pat. No. 8,541,567 B2, issued Sep. 24, 2013, Schramm, Transition state structure of 5′-methylthioadenosine/s-adenosylhomocysteine nucleosidases.

60. U.S. Patent Application Publication No. 2010/0062995, published Mar. 11, 2010, Schramm, Transition state structure of human 5′methylthioadenosine phosphorylase.

61. U.S. Patent Application Publication No. 2011/0301104, published Dec. 8, 2011, Schramm, Transition state structure of orotate phosphoribosyl transferases and uses thereof.

62. U.S. Patent Application Publication No. 2007/0275988, published Nov. 29, 2007, Schramm, Transition state structure and inhibitors of thymidine phosphorylases.

63. PCT International Publication No. WO 2013/126370 A1, published Aug. 29, 2013, Albert Einstein College of Medicine of Yeshiva University, HIV-1 protease transition state and uses thereof.

1. A system comprising a non-transitory computer-readable medium coupled to one or more data processing apparatus having instructions stored thereon which, when executed by the one or more data processing apparatus, cause the one or more data processing apparatus to perform a method comprising:
(i) obtaining kinetic isotope effects on human Nuclear receptor SET Domain containing protein 2 (NSD2)-catalyzed methylation of histone H3 lysine 36 to obtain the NSD2 transition state structure,
wherein the NSD2 transition state comprises the structure [symbol]
(ii) obtaining the molecular electrostatic potential at the van der Waals surface computed from the wave function of the NSD2 transition state and the geometric atomic volume of the NSD2 transition state; and
(iiia) identifying from a library of compounds a chemically stable compound that resembles the molecular electrostatic potential at the van der Waals surface computed from the wave function of the NSD2 transition state and the geometric atomic volume of the NSD2 transition state, or
(iiib) designing a chemically stable compound that resembles the molecular electrostatic potential at the van der Waals surface computed from the wave function of the NSD2 transition state and the geometric atomic volume of the NSD2 transition state;
wherein the chemically stable compound that resembles the molecular electrostatic potential at the van der Waals surface computed from the wave function of the NSD2 transition state and the geometric atomic volume of the NSD2 transition state is a putative inhibitor of NSD2.

2. (canceled)

3. A computer implemented method performed using a system comprising a non-transitory computer-readable medium coupled to one or more data processing apparatus having instructions stored thereon, the method comprising:
(i) obtaining kinetic isotope effects on human Nuclear receptor SET Domain containing protein 2 (NSD2)-catalyzed methylation of histone H3 lysine 36 to obtain the NSD2 transition state structure,
wherein the NSD2 transition state comprises the structure [symbol]
(ii) obtaining the molecular electrostatic potential at the van der Waals surface computed from the wave function of the NSD2 transition state and the geometric atomic volume of the NSD2 transition state; and
(iiia) identifying from a library of compounds a chemically stable compound that resembles the molecular electrostatic potential at the van der Waals surface computed from the wave function of the NSD2 transition state and the geometric atomic volume of the NSD2 transition state, or
(iiib) designing a chemically stable compound that resembles the molecular electrostatic potential at the van der Waals surface computed from the wave function of the NSD2 transition state and the geometric atomic volume of the NSD2 transition state;
wherein the chemically stable compound that resembles the molecular electrostatic potential at the van der Waals surface computed from the wave function of the NSD2 transition state and the geometric atomic volume of the NSD2 transition state is a putative inhibitor of NSD2.

4-8. (canceled)

9. The system of claim 1, which further comprises synthesizing the compound.

10. The system of claim 1, which further comprises testing the compound for inhibitory activity to NSD2.

11. (canceled)

12. A method of screening for an inhibitor of human Nuclear receptor SET Domain containing protein 2 (NSD2), the method comprising the steps of:
(i) measuring kinetic isotope effects on the NSD2-catalyzed methylation of histone H3 lysine 36 to obtain the NSD2 transition state structure,
wherein the NSD2 transition state comprises the structure [symbol]
(ii) determining the molecular electrostatic potential at the van der Waals surface computed from the wave function of the NSD2 transition state and the geometric atomic volume of the NSD2 transition state;
(iiia) obtaining a chemically stable compound that resembles the molecular electrostatic potential at the van der Waals surface computed from the wave function of the NSD2 transition state and the geometric atomic volume of the NSD2 transition state, or
(iiib) using a computer to design a chemically stable compound that resembles the molecular electrostatic potential at the van der Waals surface computed from the wave function of the NSD2 transition state and the geometric atomic volume of the NSD2 transition state, and synthesizing the compound; and
(iv) testing the compound for inhibitory activity to NSD2 by determining if the compound inhibits NSD2-catalyzed methylation of histone H3 lysine 36,
wherein a compound that inhibits NSD2-catalyzed methylation of histone H3 lysine 36 is an inhibitor of NSD2.

13. A method of inhibiting NSD2 comprising obtaining a NSD2 inhibitor by the system of claim 1, and contacting NSD2 with the compound.

14. A method of treating a subject having a cancer comprising obtaining a NSD2 inhibitor by using the system of claim 1, and administering the compound to the subject in an amount effective to inhibit NSD2.

15. The method of claim 14, wherein the cancer is multiple myeloma, neuroblastoma, glioblastoma, prostate cancer or breast cancer.

16. The system of claim 1, wherein the transition state is a S_{N}2 transition state where a positive charge is distributed between a leaving group, a transferring group and a nucleophile.

17. The system of claim 1, wherein the transition state has a C—N distance of 1.8 Å and a C—S distance of 2.6 Å, or the transition state has a C—N distance of 2.10 Å and a C—S distance of 2.53 Å.

18. (canceled)


SEQUENCE LISTING (1 sequence)

SEQ ID NO: 1 - protein, 1365 aa, Homo sapiens
MEFSIKQSPLSVQSVVKCIKMKQAPEILGSANGKTPSCEVNRECSVFLSKAQLSSSLQEGVMQKFNGHDALPFIPADKLKDLTSRVFNGEPGAHDAKLRFESQEMKGIGTPPNTTPIKNGSPEIKLKITKTYMNGKPLFESSICGDSAADVSQSEENGQKPENKARRNRKRSIKYDSLLEQGLVEAALVSKISSPSDKKIPAKKESCPNTGRDKDHLLKYNVGDLVWSKVSGYPWWPCMVSADPLLHSYTKLKGQKKSARQYHVQFFGDAPERAWIFEKSLVAFEGEGQFEKLCQESAKQAPTKAEKIKLLKPISGKLRAQWEMGIVQAEEAASMSVEERKAKFTFLYVGDQLHLNPQVAKEAGIAAESLGEMAESSGVSEEAAENPKSVREECIPMKRRRRAKLCSSAETLESHPDIGKSTPQKTAEADPRRGVGSPPGRKKTTVSMPRSRKGDAASQFLVFCQKHRDEVVAEHPDASGEEIEELLRSQWSLLSEKQRARYNTKFALVAPVQAEEDSGNVNGKKRNHTKRIQDPTEDAEAEDTPRKRLRTDKHSLRKRDTITDKTARTSSYKAMEAASSLKSQAATKNLSDACKPLKKRNRASTAASSALGFSKSSSPSASLTENEVSDSPGDEPSESPYESADETQTEVSVSSKKSERGVTAKKEYVCQLCEKPGSLLLCEGPCCGAFHLACLGLSRRPEGRFTCSECASGIHSCFVCKESKTDVKRCVVTQCGKFYHEACVKKYPLTVFESRGFRCPLHSCVSCHASNPSNPRPSKGKMMRCVRCPVAYHSGDACLAAGCSVIASNSIICTAHFTARKGKRHHAHVNVSWCFVCSKGGSLLCCESCPAAFHPDCLNIEMPDGSWFCNDCRAGKKLHFQDIIWVKLGNYRWWPAEVCHPKNVPPNIQKMKHEIGEFPVFFFGSKDYYWTHQARVFPYMEGDRGSRYQGVRGIGRVFKNALQEAEARFREIKLQREARETQESERKPPPYKHIKVNKPYGKVQIYTADISEIPKCNCKPTDENPCGFDSECLNRMLMFECHPQVCPAGEFCQNQCFTKRQYPETKIIKTDGKGWGLVAKRDIRKGEFVNEYVGELIDEEECMARIKHAHENDITHFYMLTIDKDRIIDAGPKGNYSRFMNHSCQPNCETLKWTVNGDTRVGLFAVCDIPAGTELTFNYNLDCLGNEKTVCRCGASNCSGFLGDRPKTSTTLSSEEKGKKTKKKTRRRRAKGEGKRQSEDECFRCGDGGQLVLCDRKFCTKAYHLSCLGLGKRPFGKWECPWHHCDVCGKPSTSFCHLCPNSFCKEHQDGTAFSCTPDGRSYCCEHDLGAASVRSTKTEKPPPEPGKPKGKRRRRRGWRRVTEGK